(19) United States
(12) Patent Application Publication
(10) Pub. No.: US 2009/0097623 A1
(43) Pub. Date: Apr. 16, 2009

(54) Remote Patient Handset and System for Remote Collection of Bio-Metric Data and Device Control

(76) Inventor: Gowrishankar Bharadwaj, Commerce City, CO (US)

Correspondence Address: MANUEL F. DE LA CERRA, 6885 CATAMARAN DRIVE, CARLSBAD, CA, 92011, US

(21) Appl. No.: 11/870,309

(22) Filed: Oct. 10, 2007

(51) Int. Cl. H04M 11/00

(52) U.S. Cl. 379/106.02

(57) ABSTRACT

A wireless mobile device is provided, typically in the form of a handset that is cable of providing voice and data communication using a wide-area wireless carrier system. The wireless handset has an associated bio-metric sensor, which may be integrally formed with the handset or spaced apart and connected with a wired or wireless connection. A patient uses bio-metric sensor to locally collect data, and then transmit that data to a medical server using the wireless handset. In some cases, the wireless handset may also process the data to transmit result or summary information. In other cases, the wireless handset may process the data to perform a local operation, such as signaling an alarm or displaying results to the patient, or to make an adjustment in the bio-metric sensor or other local medical device. In some cases the wireless handset may also receive commands from the medical server, and make an adaptation to the bio-metric sensor or other medical device, such as a medication pump.

### BACKGROUND

The field of the present invention is devices and processes for remote collection of bio-metric data using wireless mobile devices, and in some cases, the remote control of the wireless mobile device or a bio-metric sensor.

The medical device industry has advanced to produce smaller and more effective biometric sensors. These sensors are used by a medical provider, such as a doctor or nurse, to collect important biological data regarding a patient. This data may include, for example, ECG, EKG, brain wave, temperature, pulse rate, hydration, blood chemistry, or glucose levels. In some cases, the provider is able to review the collected data and make an immediate therapeutic diagnosis, such as the case in finding an elevated temperature. In other cases, it is only by collecting data over an extended period of time that important medical results can be evaluated. In these cased, the medical provider may have to make several trips to the patient, or the patient will have to make several trips to the provider's office, before a meaningful result may be obtained.

In other cases, patient data is only able to be monitored after an important event has occurred, for example, a mild heart attack. In these cases, the most critical data is never collected as the patient is not in their provider's office when the attack occurs.

In one of the most challenge aspects of new drug development, a drug company typically pays for and orchestrates one or more human studies regarding safety and efficacy. These studies are time consuming and expensive, and rely on the voluntary participation of human subjects. These subjects must take their dosages according to predefined guidelines, and submit themselves for continual evaluation at a provider's office. Since the provider has only limited interaction with each subject, there is a substantial risk that the subject will forget of fail to follow the dosing regimen, will fail to participate in required follow-up and testing, or will have a negative reaction that is not detected in the short evaluation visit.

Accordingly, there is a need for better collection and use of bio-medical data.

### SUMMARY

Briefly, the present invention provides a wireless mobile device, typically in the form of a handset that is cable of providing voice and data communication using a wide-area wireless carrier system. The wireless handset has an associated bio-metric sensor, which may be integrally formed with the handset or spaced apart and connected with a wired or wireless connection. A patient uses bio-metric sensor to locally collect data, and then transmit that data to a medical server using the wireless handset. In some cases, the wireless handset may also process the data to transmit result or summary information. In other cases, the wireless handset may process the data to perform a local operation, such as signaling an alarm or displaying results to the patient, or to make an adjustment in the bio-metric sensor or other local medical device. In some cases the wireless handset may also receive commands from the medical server, and make an adaptation to the bio-metric sensor or other medical device, such as a medication pump.

In one example, a patient uses a bio-metric sensor to collect glucose blood-chemistry data from time to time. The glucose sensor may be integral to a mobile wireless handset, or may connect using a wire or wireless communication. The mobile wireless handset may locally process the glucose level information, and present information or instructions to the patient. The wireless handset may also communicate the raw or processed data to medical server over a wireless communication channel, such as CDMA, GPRS, or UMTS. With greater computational and storage capability, the medical server may provide additional dosing or instructions to the patient. These messages may be delivered to the patient by voice or through a data message. In other cases, the medical server may send the data, or in a more critical case, an alert, to a medical provider or to an emergency responder. In some cases, the patient may have a local device for administering insulin or other medication, which may be activated or adapted from a command sent from the wireless mobile handset. This command may be locally generated responsive to a timer or to collected data, or may be a command received from a medical provider to from a medical server.

Advantageously, the disclosed patient handset enables high quality medical care to be more efficiently provided. For example, a patient is able to collect bio-metric data at almost any location, and at any time, allowing for more frequent and consistent data collection, with minimal interruption to the patient's schedule. Medical providers are able to more closely monitor patient conditions and progress, and communicate with those patients using voice or data channels. For example, a doctor may talk to a patient while viewing data results in near-real time, even though both the doctor and the patient are hundreds of miles apart. Due to the ubiquitous nature of mobile handsets, such patient handsets may be readily deployed, and used in almost every geographic location.

### BRIEF DESCRIPTION OF THE DRAWINGS

The invention can be better understood with reference to the following figures. The components within the figures are not necessarily to scale, emphasis instead being placed upon clearly illustrating the principles of the invention. Moreover, in the figures, like reference numerals designate corresponding parts throughout the different views. It will also be understood that certain components and details may not appear in the figures to assist in more clearly describing the invention.

FIG. 1 is a simplified block diagram of a system for remote bio-medical data collection and device control in accordance with the present invention;

FIG. 2 is a diagram of a patient handset constructed for use in a bio-medical data collection system in accordance with the present invention;

FIG. 3 is a diagram of a patient handset constructed for use in a bio-medical data collection system in accordance with the present invention;

FIG. 4 is flowchart of a process of using a biomedical sensor that is associated with a wireless mobile handset in accordance with the present invention;

FIG. 5 is flowchart of a process for enabling a medical provider to receive data from a remote data collection device, and to issue commands to the control the device or sensor in accordance with the present invention; and

FIG. 6 is a block diagram of processes, algorithms, and data structures used in a medical server in accordance with the present invention;

### DETAILED DESCRIPTION

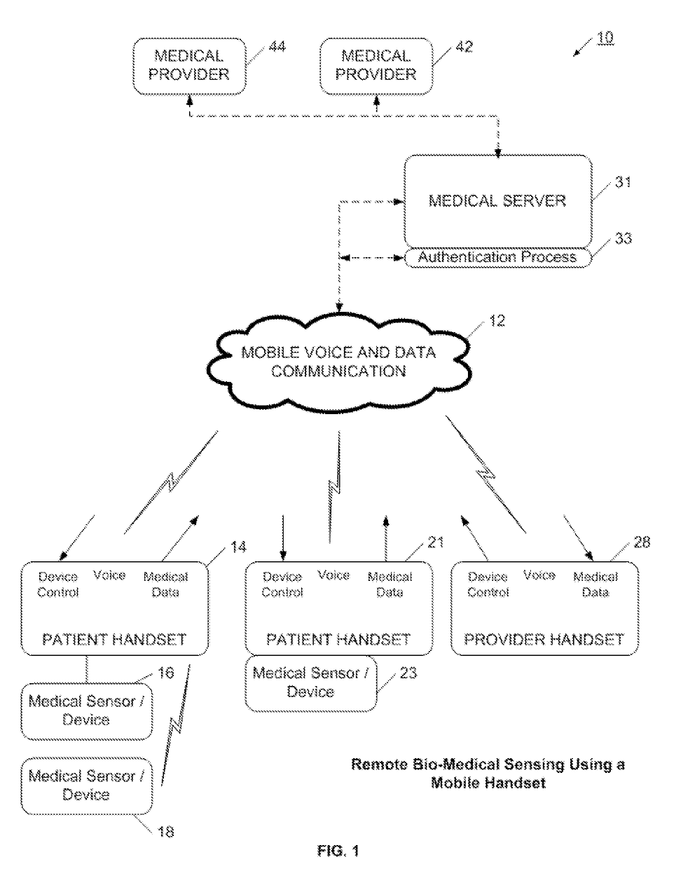

Referring now to FIG. 1, a distributed biometric system is illustrated. System 10 advantageously enables the remote collection of biometric data, the automated communication of the biometric data to medical personnel, and the ability of medical providers to react to and control the biometric collection devices. In system 10, data collection, communication, and control are provided in an authenticated and secure manner, assuring patient privacy as well as safely assisting the delivery of quality medical care.

Biometric system 10 uses commercially available mobile voice and data communication systems 12. Mobile communication system 12 may be operated by a telecommunication provider, and may use communication standards promulgated by national or international standards bodies. For example, mobile communication system 12 may comply with CDMA, CDMA 2000, WCDMA, EVDO, EVDV, GSM, GPRS, EDGE, PHS, PCS, or other telecommunication standards. The telecommunication system may also include or rely upon other communication protocols such as WiFi, 802.11, Bluetooth, WiMax, or other local or wide area data network. However, the reach and ubiquitous nature of the mobile telephone systems make the mobile telephone system the network of choice. Accordingly, the descriptions provided herein will describe the invention operating using a mobile telecommunications system, however it will be appreciated that other communication and data networks may be used.

Mobile communication system 12 enables remote voice and data communication with mobile handsets, such as mobile handsets 14, 21, and 28. The communication of voice and data between a mobile communication system and its associated mobile handsets is well known, so will not be described herein. In a similar way, the construction and deployment of mobile handsets is well known, so will not be described in detail. In one example, patient handset 14 allows voice communication to human medical providers, as well as data communication with a medical server 31. In some cases, medical providers 42 and 44 may use medical server 31 to send device control commands to the patient handset 14.

Patient handset 14 couples to a medical or biometric sensor 16. In one example, the medical sensor connects using a cable or line, and in another example, medical sensor 18 connects using a wireless communication, such as Bluetooth. The medical sensors 16 and 18 may be any kind of biometric or medical sensor useful for collecting patient data. For example, the sensors may provide an audio signal for hearing heart, lung, or breathing activity; may sense temperature, heart rate, blood pressure, glucose level, or other blood chemistry information; or may measure skin hydration, environment data, exercise data, or location information. It will be appreciated that the biometric or medical sensors may be constructed and configured to collect a wide range of useful information regarding patients and their environment.

In another example, patient handset 21 has a medical sensor 23 integrally formed with the handset. In this way, the patient uses a single device for voice and data communication, as well as collecting medical data. Although this structure may provide a particularly efficient housing, the integrally formed medical sensor handset provides less flexibility then the discrete sensors discussed with reference to patient handset 14. The patient handset 14 or 21 may operate local application software for controlling the handset's respective sensor or sensors. For example, the patient handset may determine when data is collected and when data is transferred to the medical server 31. This determination may be done according to a time schedule; may be responsive to data collected at one or more medical sensors; or may be initiated by a local command given by the patient or a medical provider. It will be appreciated that other processes and triggers may be used to start or stop data collection and transfer data to medical server.

The collected data may be sent to medical server 31. The data may be sent in near real time, or may be collected and processed in the patient handset and then communicated to the medical server 31 from time to time. The medical server 31 is preferably stationed within the control of the mobile communication system 12. In this way, enhanced security may be established between patient handsets and the medical server 31. If the medical server is outside the protected environment of the mobile communication system, then additional authentication processes 33 must be used to assure the private and secure transmission of data, as well as to authenticate access to the medical server. A robust and flexible association and authentication process has been fully described in co-pending U.S. patent application Ser. No. 11/296,077 filed Dec. 7, 2005 and titled “Wireless Controller Device”, which is incorporated herein in its entirety. It will be appreciated that other authentication, association, and security processes may be used. Once the medical server 31 has received data from the patient handsets, that data may be processed or made available for use by medical providers, such as medical provider 42 and 44. It will be appreciated that medical server 31 may operate automated processes for monitoring received data, and may automatically generate alarms or messages responsive to analyzing patient data.

In some cases, a medical provider may also be operating remotely, and may use a provider handset 28 for both voice communication and for receiving data from the medical server 31. Advantageously, biometric system 10 enables secure collection of medical data for patient, the transmission of that medical data to a medical server, and distribution and use of the data by distributed medical providers. Further, data collection and transmission may occur simultaneously with voice communication with the patient. In this way, a medical provider may be in voice communication with a patient while monitoring near real time medical data.

To this point, the distributed biometric system 10 has been described as a data collection and distribution network. As an extension, system 10 also allows medical providers, such as medical providers 42, 44, and 28 to control and adjust the data collection process. For example, the authenticated medical providers may cause commands to be sent to patient handsets 14 and 21 for changing the way data is collected. These commands may be used with in the patient handset for adjusting the timing of data collection and transmission, or may be used with in medical sensors 16, 18 or 23 for adjusting sensor configurations.

The biometric system 10 may be advantageously used in several practical applications. For example, system 10 may enable the automated and remote monitoring of patients. In this way, medical data is collected according to predefined triggers, and that data may be locally or centrally processed to evaluate patient condition. Responsive to processing the medical data, the medical server or medical providers may determine when a patient needs more direct contact with a medical facility, or in some cases may even initiate or adapt medical treatment by sending commands to a local medical device. In this way, patients may be closely monitored with less intrusion into their lives, and a more advanced medical treatment sought before conditions become critical. More effective medical treatment may thereby be delivered to patients in a more comfortable and timely manner.

In another example of use, clinical trials may use system 10 for controlling clinical studies. A medical server may be used to notify patients when to take a medication, or may even send commands to local medical devices to administer local doses. The medical server may also interrogate the patient with text messages, and solicit current medical information from the patient, or may call the patient using a voice capability the handset, and have the patient give an oral report. Since the patient handset has one or more local sensors, the medical server may also receive real-time or processed data from patients. In this way, more complete and accurate information may be obtained for trial studies, and patients having complications may be more quickly identified and removed from the study. Further, the cost of managing human clinical studies has skyrocketed, with some studies costing more than $30,000 per patient per year of study. Accordingly, a more efficient way of monitoring patients and collecting data could dramatically reduce study costs and increase the study's reliability, allowing beneficial drugs to come to market more quickly.

In other examples, system 10 may be used to monitor athletes to assess performance and stress levels, or may be used to monitor military personnel or police. Also, even though the patient handset has been described as being associated with a single patient, in some cases the patient handset may be a handset used by a medical provider, such as an emergency responder. In this way, the emergency responder moves to the location of the patient, and then uses the patient handset to collect the patient's medical data, and transmit the patient data to a nearby hospital or other medical provider. In this way, the local hospital or medical provider may better understand patient condition, and either be prepared for the patients arrival, or even direct the patient to an alternative facility. With the efficient and accurate transmission of medical data, time may be saved in moving the patient to a preferred medical treatment location.

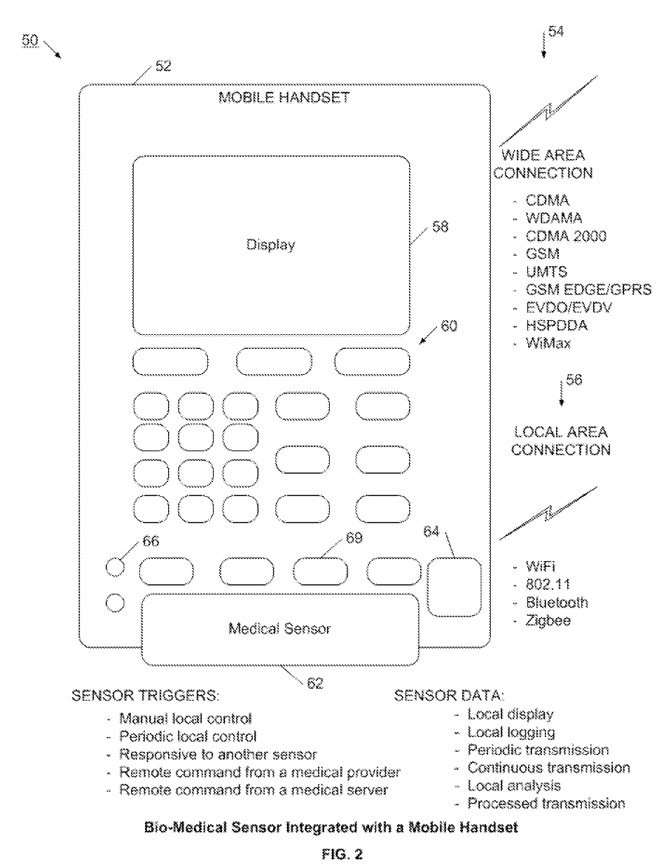

Referring now to FIG. 2, a patient handset system 50 is illustrated. Mobile handset 50 is similar to patient handset 21 described with reference to FIG. 1, and is intended to operate within a distributed biometric system 10. Handset 50 has a housing 52 holding a standard mobile handset. Typically, a mobile handset 52 will include a textual or graphical display 58, input keys 60, as well as internal circuitry for operating local programs as well as wide area communication. The mobile handset 52 may operate according to one or more wide area connection 54, such as CDMA, WCDMA, UMTS, GSM, WiFi, or other wide area voice and data network. Typically, these wide-area connections are operated by a communication carrier, and the mobile handsets are particularly constructed to operate in a specific carrier's network. In some cases, mobile handset 52 also has a local area connection such as Bluetooth or 802.11. The local area connection 56 may be useful for connecting to other medical sensors, or to other peripheral devices such as headsets, medical devices, or hands-free car kits. Handset 52 also has an integrated medical sensor 62. The medical sensor 62 may be constructed as a stethoscope, a heart rate monitor, a blood pressure monitor, a glucose monitor, or other biometric sensor. The mobile handset 52 may also have control keys 69 for allowing the patient or a medical provider to directly interact with medical sensor 62. A speaker 64 may also be provided for sounding alarms or giving instructions. It will also be appreciated that the handsets regular speakerphone or earpiece may be used in this capacity. The mobile handset may also have alerts or alarm lights 66 associate with the medical sensor 62. For example, lights 66 may indicate that a glucose level is dangerously low, or that the medical sensor is no longer receiving a required signal. The display 58 may also be used to display instructions on use of the medical sensor 62, or may be used for outputting results or alarm information.

Medical sensor 62 may initiate its data collection responsive to a manual local control, as when a patient or medical provider interacts with control buttons 69. The medical sensor 62 may also operate responsive to an application running within the mobile handset itself, and thereby may periodically begin data collection, or take data collection responsive to some other application or trigger provided by the mobile handset. In another example, and other local medical sensor provides trigger data for medical sensor 62. The mobile handset may also receive a command from a medical provider or from a medical server, and responsive to receiving the command, initiate or a just medical sensor 62. The sensor data may be displayed locally to the patient or local medical provider, or the data may be logged in the memory of the mobile handset. The data may also be sent continuously to an associated medical server in near real time, or may be stored locally and periodically transmitted. Mobile handset 52 may also provide local analysis of data, and present local results to the patient or local medical provider. For example, medical sensor 62 may collect blood glucose information, process the data locally, and process and present the results locally. The raw data or resulting blood level data may then be transmitted to a medical server.

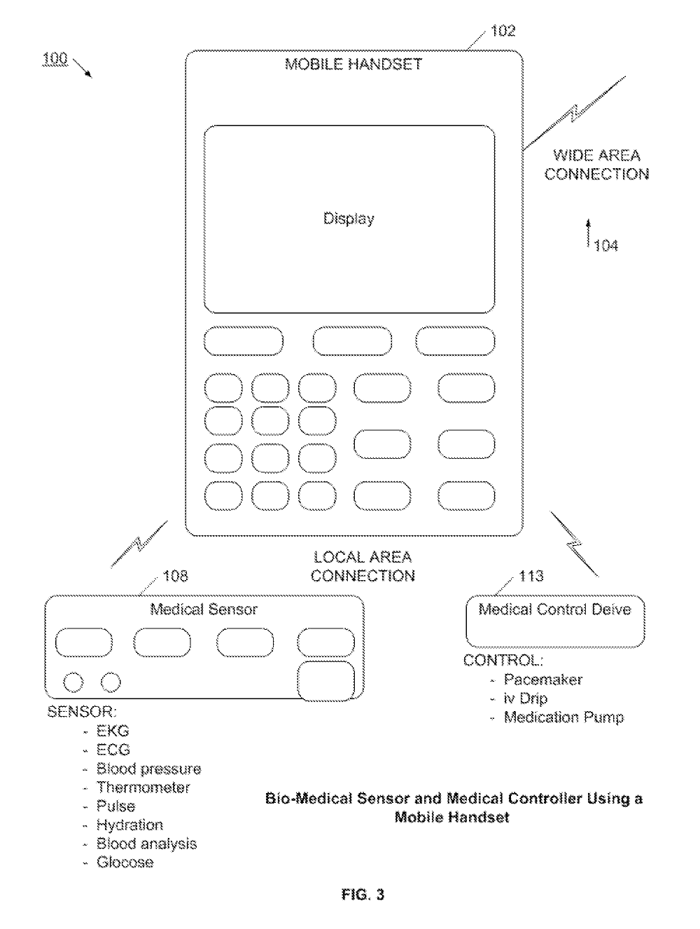

Referring now to FIG. 3, patient handset system 100 is illustrated. Patient handset 100 is similar to patient handset 21 described with reference to FIG. 1 and has many similarities with patient handset system 50 described with reference to FIG. 2. Accordingly, mobile handset system 100 will be described with less detail. Patient handset system 100 has mobile handset 102 having a wide area connection 104 for transmitting and receiving data and voice. Mobile handset 102 also has a local area connection such as Bluetooth, Zigbee, or 802.11. The local area connection may be used to connect to a medical sensor 108, or to a medical control device 113, for example. The medical sensor 108 may include various control keys, alarms, and displays. The medical sensor 108 may be, for example, an EKG, ECG, blood pressure, thermometer, pulse, hydration, blood analysis, or glucose sensing device. It will be appreciated that other types of sensors may be used, or that multiple sensors may be connected. In operation, medical sensor 108 is positioned on or adjacent patient, and collects data responsive to a local or remote trigger. From time to time or in real time the medical sensor 108 communicates data back to the mobile handset 102, which periodically transmits the data back to a medical server. The mobile handset will too may also receive commands from a medical provider or from the medical server for adjusting medical sensor 108. In this way, a remote medical provider may interact with medical sensor 108 or the application interacting with the medical sensor operating on mobile handset 102. In another control example, a medical control device 113 also uses the local area connection to interact with the mobile handset 102. This medical control device 113 may be a pacemaker, IV drip, or medication pump, for example. This medical control device 113 may receive the command directly from mobile handset 102, or the command may have been initiated from a medical server or a human medical provider, and communicated to the mobile handset via the wide area connection 104.

In one specific example, mobile handset 102 is used by a patient having a pain medication administered using a medication pump. The medication pump has a medical control device 113 which sets the flow rate or duty cycle or period of operation. A medical sensor 108 may be attached to the patient to monitor pulse rate, skin hydration, or other biometric indicator of pain. Further, the patient may use mobile handset 102 to communicate verbally to a medical provider. Responsive to receiving data that pain has increased, or responsive to a verbal communication from the patient, a medical provider may send a command to medical control device 113 to increase pain medication. In this way, a medical provider is able to accurately evaluate the patients condition, including speaking with the patient, and enable a change in medication delivery from a remote location. Accordingly, patient system 100 facilitates the timely and efficient delivery of high quality medical care.

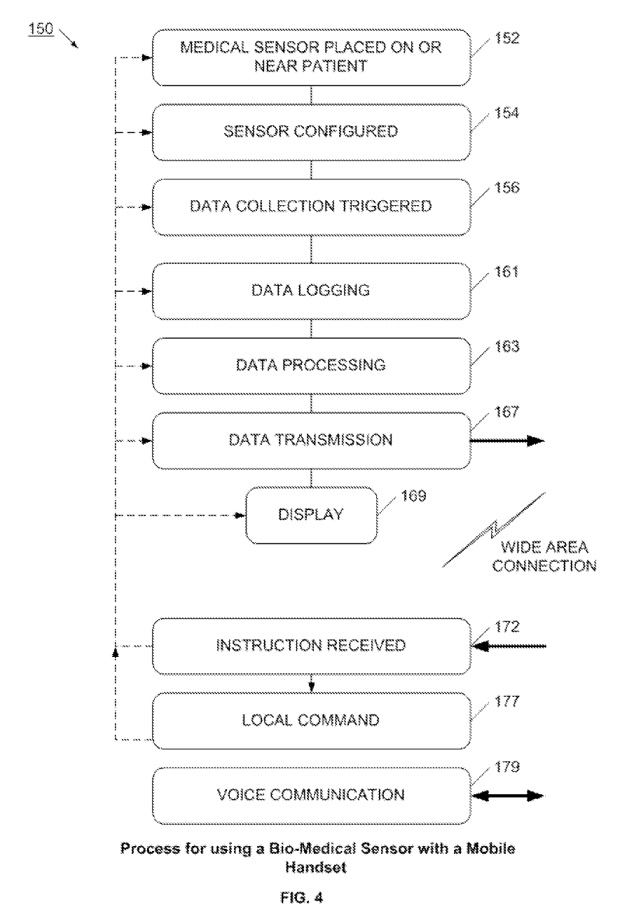

Referring now to FIG. 4, a process for using a wireless medical sensor with a mobile handset is illustrated. In process 150, a medical sensor is placed on or near a patient as shown in block 152. This sensor may be a discrete sensor that connects or couples to a handset, or may be a sensor integrally formed in a wireless mobile handset. The sensor is configured as shown in block 154. Configuring the sensor may include using local buttons or local commands from the mobile handset, and may include further instruction or commands from a medical server or remote medical provider. Data collection is triggered as shown in block 156. Data collection may be triggered by a local command received at the sensor or on the handset, may be provided by an application operating on the mobile handset, or may be responsive to a command received from the medical server or remote medical provider. The collected data may be locally logged into memory as shown in block 161, and may be locally processed as shown in block 163. In some cases, the data logging and data processing steps may not be used, with raw data being transmitted to the medical server in near real time. In other cases, the logged data and processed data may be sent to the medical server as shown in block 167. The data may also be locally displayed, as well as local results on display at 169. The command may be received at the mobile handset from the wide area connection as shown in block 172. This command may come directly from the medical server, from a medical provider connected to the medical server, or even from a medical provider operating a mobile handset.

In another example, a command may be generated locally as shown in block 177. This local command may be from an application operating on the mobile handset, or may be responsive to a patient or medical provider pressing a key. Any of these instructions may then be used to make adjustments in the data collection process. For example, the instruction may affect how the sensor is configured, what triggers the data collection, the amount of data logged, the type of data processing performed, or the timing of data transmissions. In this way, process 150 facilitates the secure and flexible collection of medical data, the use of the medical data by medical providers irrespective of their location, and the adaptation of the sensor and patient handset. Of course, the patient handset may facilitate voice communication 179 between the patient and medical providers, even while medical data is being collected and transmitted.

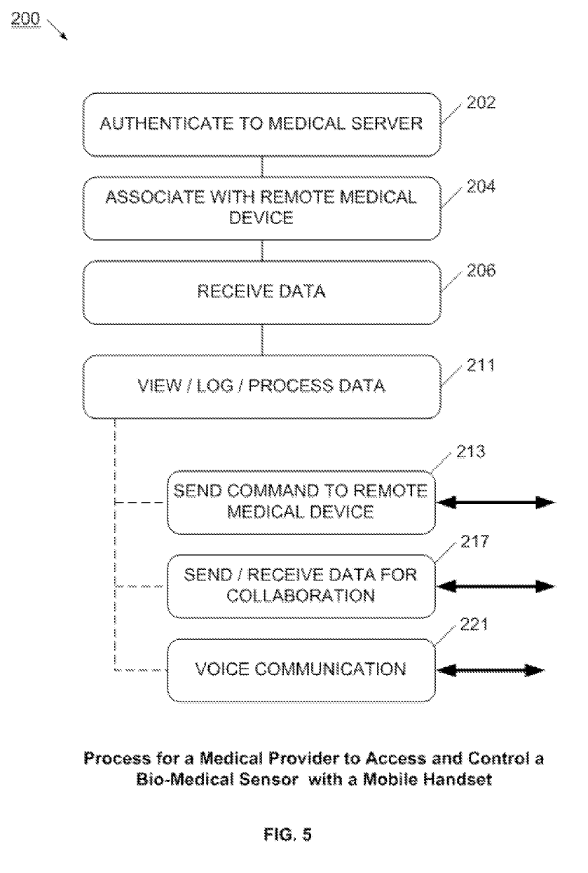

Referring now to FIG. 5, a process for a medical provider to access and control a biomedical sensor is illustrated. Process 200 allows a remote medical provider to access medical data, evaluate medical data, and control one or more devices associated with a patient. Although the medical provider may be connected to a medical server, in some cases the medical provider may be operating using a wireless mobile device, such as a portable computer or wireless handset. In these cases, the wireless mobile device provides a secure process for authenticating the medical provider to the medical server as shown in block 202. Once the medical provider has been authenticated to the medical server, then the medical provider has to be associated with particular patients and their associated remote medical devices as shown in block 204. In this way, a particular medical provider is only able to access data and control devices for that provider's set of patients.

Once the medical provider has been authenticated and associated with their set of patients, the medical provider may select a particular patient, and receive data collected by that patient's medical sensor or medical sensors. As previously discussed, this data may be real-time, batch transmitted, and may include summary or processed results. The medical practitioner then may view and store this medical data or may provide additional analytic tools as shown in block 211. Responsive to viewing the data, the medical provider may send a command to remote medical device at the patient's location as shown in block 213. This command may be used to further adapt the medical sensor, or may provide control for another device, such as an IV pump, at the patient location.

In another example, the medical provider may stand messages or data information to other medical providers for collaboration as shown in block 217. In this way, multiple remote medical providers may cooperate in assisting a single patient, and all providers will be using the same medical data information. While receiving and analyzing medical information from the patient, the medical provider may also be in voice communication with the patient as shown in block 221. Of course, the medical provider may also use forced vacation 221 to discuss the patient with other medical providers.

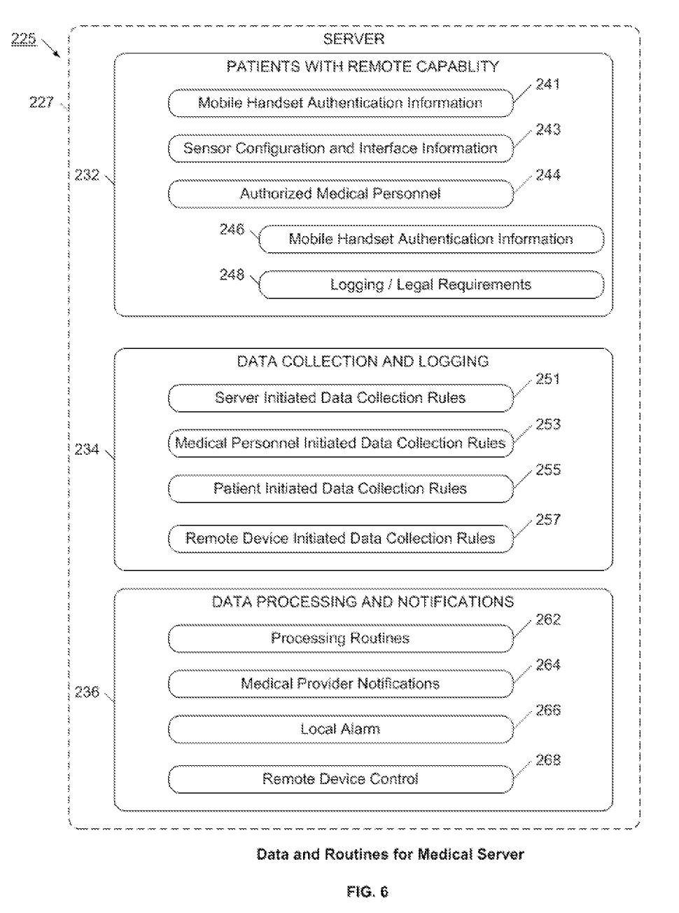

Referring now to FIG. 6, medical server processes 225 are illustrated. The connection of a medical server to a mobile communications system, as well as the operation of a general computer server, are well known, so will not be described in detail. Instead, the general processes operating on a medical server are described. Medical server 227 has processes 232 for authenticating and associating mobile devices with the medical server. The authentication and association processes are simplified when the medical server operates with in the controlled environment of the mobile communications system, but the medical server may also be connected on a more general network system such as the Internet. The server has mobile handset authentication information 241, which is useful for authenticating patient handset to the medical server. The mobile handset authentication information 241 may include the mobile identification number for the handset, a serial number for the handset, IP address for the handset, or other identification information. The authentication information may also have carrier information, and password requirements for the user. Once a handset has been authenticated to the server, the server may then associate a particular patient handset with that handsets authorized biometric sensors, and may provide sensor configuration and interface information as shown in block 243. This information may be specific to the particular sensor at a patients handset, or may be global to a class of products. In another example, sensors may be configured according to the particular medical requirements of the patient.

The server 227 also maintains information for authorizing medical personnel 244. Some medical personnel may login through existing server client processes, while others may access the server using their mobile handsets. For those using the mobile handsets, a mobile handset authentication information system to 46 is provided. In this way, a particular medical provider's handset may be authenticated to the server, and the medical provider associated with an authorized set of patients and patient records. Logging and legal requirements 248 may also be set on a global basis, a provider bases, or a patient basis. In this way, appropriate records may be maintained as to patient care.

Processes 232 enable server 227 to communicate with a patients handset and its associated sensors, as well as access rules specific to that patient. For example rules 234 may include rules for when the server initiates data collection as shown in block 251. Alternatively, authorized medical personnel may initiate data collection as shown in block 253, or a patient may be allowed to initiate the collection as shown in block 255. In other cases, other remote devices may be allowed to trigger or initiate data collection as shown in block 257. The data collection rules also may include information as to the trigger for initiating data collection, how much data to store locally, then to transmit data to medical server, and what type of local display and processing may be allowed. In some cases, the collected medical data may be processed locally and used for further adapt in the medical sensor or local application.

In other cases, server analytics 236 are applied to the received medical data by server 227. Processing routines 262 may be applied to incoming data, and provided certain thresholds or patterns are seen, notifications may be sent to medical providers 264 or alarms may be generated 266. The medical provider notifications 264 may include messages, automated phone calls, or other forms of notification. The alarm may also be used to notify medical providers, or may be set as a sound, illumination, or display on the patients handset. For example, if the processing routines 260 to determine that a heart rate is too high, a local alarm may be sounded at the patient's handset to warn the patient to reduce their level of exertion. In another example, responsive to the processing routines to 62, the server may send commands to the patient's handset to 68. These commands may then be used to adapt or configure the medical sensor, or may be used to set operation of another local medical device.

While particular preferred and alternative embodiments of the present intention have been disclosed, it will be appreciated that many various modifications and extensions of the above described technology may be implemented using the teaching of this invention. All such modifications and extensions are intended to be included within the true spirit and scope of the appended claims.

What is claimed is:

1. A bio-metric mobile handset, comprising:
a wireless mobile handset having a wide area voice and data communication path, a display and a set of input keys; and
a bio-metric sensor coupled to the mobile handset.

2. The bio-metric mobile handset according to claim 1, wherein the bio-metric sensor and the wireless mobile handset are in the same housing.

3. The bio-metric mobile handset according to claim 1, wherein the bio-metric sensor is a discrete device communicating to the wireless mobile handset using a wireless local communication path.

4. The bio-metric mobile handset according to claim 3, wherein the local communication path is Bluetooth, 802.11, or Zigbee.

5. The bio-metric mobile handset according to claim 1, wherein the wide are communication path is CDMA, WCDMA, CDMA2000, UMTS, GSM, GPRS, EDGE, WiFi, or WiMax.

6. The bio-metric mobile handset according to claim 1, wherein the sensor is constructed to detect a breathing signal, a blood-chemistry signal, an EKG signal, and ECG signal, a hydration signal, a heart-rate signal, a blood pressure signal, or a glucose-level signal.

7. The bio-metric mobile handset according to claim 1, further including a second bio-metric sensor.

8. The bio-metric mobile handset according to claim 1, further including control keys dedicated to operation of the bio-metric sensor.

9. The bio-metric mobile handset according to claim 1, further including an audio device, lamp, or display dedicated to presenting output information for the bio-metric sensor.

10. The bio-metric mobile handset according to claim 1, further including a control device arranged to control a medical device.

11. The bio-metric mobile handset according to claim 1, wherein the control device connects to a pacemaker, an iv drip controller, a pump, or a medication pump.

12. A method operating on a mobile wireless handset, comprising:
receiving bio-metric data from a bio-metric sensor;
establishing data communication with a medical server; and
transmitting the bio-metric data to the medical server.

13. The method according to claim 12, further including the steps of:
receiving a command for the bio-metric sensor; and
transmitting the command to the bio-metric sensor.

14. The method according to claim 12, further including the steps of:
receiving the bio-metric data from the bio-metric sensor using a physical connection line.

15. The method according to claim 12, further including the steps of:
receiving the bio-metric data from the bio-metric sensor using a wireless local connection.

16. The method according to claim 12, further including the steps of:
processing the bio-metric data;
generating a command; and
transmitting the command to the bio-metric sensor.

17. The method according to claim 12, further including the steps of:
processing the bio-metric data;
generating a command; and
transmitting the command to another bio-metric sensor.

18. The method according to claim 12, further including the steps of:
processing the bio-metric data;
generating a command; and
transmitting the command to a medical device.

19. The method according to claim 18, wherein the medical device is a pacemaker, an iv pump, or a medication pump.

20. The method according to claim 12, further including the steps of:
processing the bio-metric data;
generating processed data; and
transmitting the processed data to a medical device.
